(19) United States
(12) Patent Application Publication
(10) Pub. No.: US 2006/0179352 A1
(43) Pub. Date: Aug. 10, 2006

(54) Systems and methods for outputting debug messages

(75) Inventors: Allen N.L. Lau, Markham (CA); Ion-Dan Calinescu, Toronto (CA); Bryan Lawrence West, Sunderland (CA)

Correspondence Address: BERESKIN AND PARR, 40 KING STREET WEST, BOX 401, TORONTO, ON, M5H 3Y2, CA

(73) Assignee: Tira Wireless Inc., Toronto (CA)

(21) Appl. No.: 11/350,129

(22) Filed: Feb. 9, 2006

Related U.S. Application Data
(60) Provisional application No. 60/651,216, filed on Feb. 10, 2005.

(51) Int. Cl. G06F 11/00

(52) U.S. Cl. 714/38

(57) ABSTRACT

A method and system of outputting a debug message from a mobile device application are disclosed. The method includes the steps of: (a) inserting an instruction set into the application which enables an application to output a debug message; (b) loading the application on the mobile device; and c) executing the application on the mobile device, such that that at least one debug message is output during execution of the application. The system includes: a) an instruction set which enables output of the debug message during execution of the application; and b) an executable module which inserts the instruction set into the application.

### CROSS-REFERENCE TO RELATED APPLICATIONS

This application claims priority to U.S. Provisional Application No. 60/651,216 filed on Feb. 10, 2005, which is incorporated by reference herein in its entirety.

### FIELD OF THE INVENTION

The invention relates to software application development for mobile devices. In particular, the invention relates to outputting debug messages.

### BACKGROUND OF THE INVENTION

A number of programming platforms provide capability to print out messages created by the software developer in order to assist the software developer to locate errors in a software application. The messages are typically output to a debug message window on the desktop computer display. This process is referred to herein as “debugging”.

For example, the Java™ programming language provides the method call System.out.printIn (“debug message”), where “debug message” represents a text string generated by the developer, the values of one or more variables, or any other information that may be of assistance to the software developer.

In Windows™-based application development, the developer may use the command OutputDebugString (“debug message”), where “debug message” has the same meaning as discussed above.

However, when applications containing the above method calls are executed on mobile devices, typically, no output is produced. This is due to the fact that this functionality is generally not enabled on mobile devices and their platforms.

Several mobile devices, such as the Sony™ Ericssson™ T610 and Motorola™ i95cl mobile telephones, do include debugging functionality. However, the debugging functionality of these devices has a number of disadvantages. In particular, proprietary software and cable must be obtained from the device manufacturer. The software runs on a desktop computer and communicates with the mobile device via the proprietary cable.

Accordingly, there is a need for a system and method for more simple and convenient debugging applications for mobile devices.

### SUMMARY OF THE INVENTION

According to a first aspect of the invention, a method of outputting a debug message from an application configured to execute on a mobile device having a display is provided. The method comprises:
a) inserting an instruction set into the application, the instruction set adapted to output at least one debug message;
b) loading the application on the mobile device; and
c) executing the application on the mobile device, wherein at least one debug message is output during execution of the application.

According to a second aspect of the invention, a system for outputting a debug message from an application configured to execute on a mobile device having a display is provided. The system comprises:
a) an instruction set adapted to output the debug message during execution of the application; and
b) an executable module adapted to insert the instruction set into the application.

### BRIEF DESCRIPTION OF THE DRAWINGS

For a better understanding of the invention and to show more clearly how it may be carried into effect, reference will now be made, by way of example only, to the accompanying drawings which show at least one exemplary embodiment of the invention and in which:

FIG. 1 is a schematic diagram of a system of outputting debug messages according to a first embodiment of the present invention;

FIG. 2A is a screenshot of an exemplary application;

FIG. 2B is a screenshot showing an example of a message window according to a first embodiment of the present invention;

FIG. 3 is a flow chart illustrating a method of outputting debug messages according to a first embodiment of the present invention;

FIG. 4 is a schematic diagram of a system of outputting debug messages according to a second embodiment of the present invention;

FIG. 5 is a flow chart illustrating a second embodiment of the method according to the present invention; and

FIG. 6 is a schematic diagram of a system of outputting debug messages according to a third embodiment of the present invention.

### DETAILED DESCRIPTION OF THE INVENTION

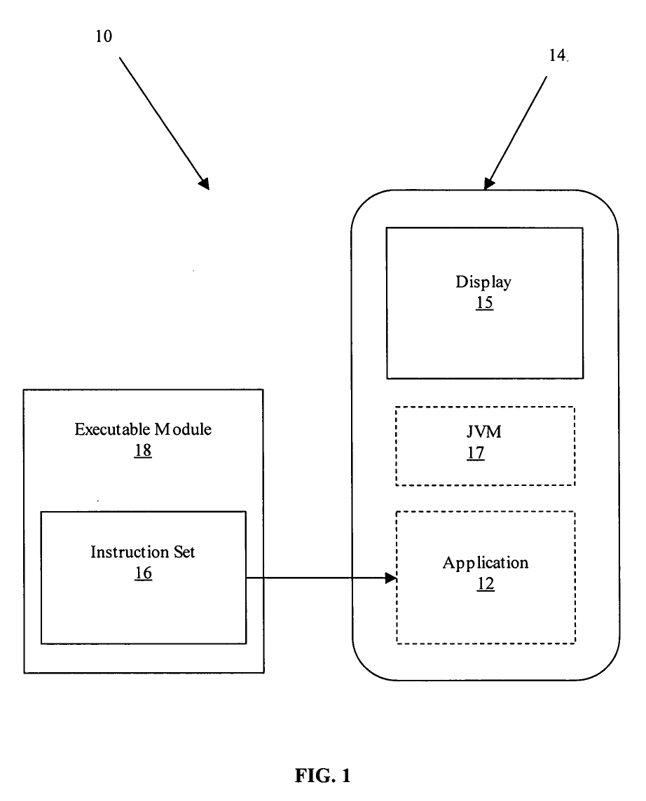

FIG. 1 shows a system 10 for outputting debug messages in an application program 12 (also referred to simply as “application”), according to a first embodiment of the present invention.

The application 12 may be any suitable application which is capable of being executed by a mobile device 14, such as for example a video game application. Preferably, the application 12 is a J2ME (Java 2 Platform Micro Edition) application. The mobile device 14 includes a display 15, such as for example a LCD display.

As used herein, “mobile device” means any portable computing device with processing and display functionality, including without limitation a cell phone, personal digital assistant (PDA), a personal email device, or a handheld electronic gaming device. For the purpose of this patent application “mobile device” also means an emulator for any of the foregoing devices running on a computer.

Preferably, a portion of the application 12, such as a paint method, generates output to the display 15 of the mobile device 14. One such method is a J2ME paint method.

J2ME applications draw to the display 15 by making calls to the Graphics interface, from a Canvas class. This interface provides methods for drawing images, text, and shapes.

When the display 15 is repainted, the Java™ virtual machine (JVM) 17 running on the mobile device 14 calls the paint method of the application 12 in the Canvas class. The paint method passes in an object implements the J2ME Graphics interface. One example of a J2ME Canvas paint method is shown below.

{

| // draw the background | | |
|---|---|---|
| graphics.setColor(0, 0, 255); | | |
| graphics.fillRect(0, 0, getWidth( ), getHeight( )); | | |
| // draw the score string | | |
| graphics.drawString(strScore, 0, 5, Graphics.TOP\|Graphics.LEFT); | | |
| // debug statement | | |
| System.out.printIn(“score=” + strScore); | | |
| // draw the player image | | |
| graphics.drawImage(imgPlayer, | plyrX, | plyrY, |

Graphics.TOP|Graphics.LEFT);
}

In the above example, a debug message is shown in bold. The debug message outputs the text string “score=” and the value of the variable strScore. However, this debug message will typically not produce any output on the mobile device 12.

Referring again to FIG. 1, the system 10 includes an instruction set 16, which is inserted into the application 12 by any type of executable module 18, such as a J2ME MIDlet. Another example of the executable module 18 is described in Applicants' co-pending U.S. patent application Ser. No. 10/975,346, filed on Oct. 29, 2004, which is incorporated by reference herein.

The instruction set 16 contains one or more pieces of program code which are inserted into the application 12, as discussed in more detail below. As used herein, “inserted” means not only the addition of code, but may also include without limitation the replacement or deletion of code in the application 12.

A method of outputting at least one debug message according to the first embodiment of the invention will now be described with reference to FIGS. 1, 2A, 2B, and 3.

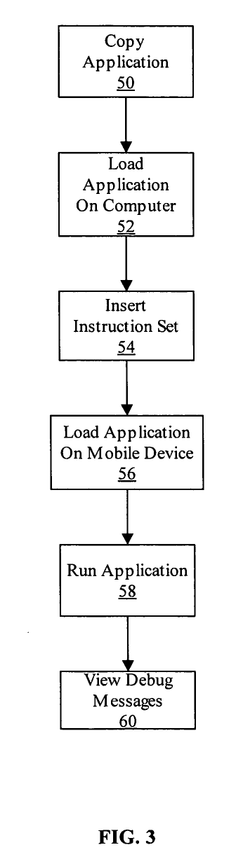

Referring now to FIG. 3, the developer makes a copy of the application 12 at step 50, and loads the copy on a desktop computer or the like at step 52. The developer then runs the executable module 18 which inserts the instruction set 16 into the application 12 (step 54).

Referring again to FIG. 1, one example of code that may be included in the instruction set 16 is a first method call which replaces the debug message in the application 12. The first method call calls a first method which adds the output of the debug message into a first-in-first-out-queue. Preferably, the queue is an array. In the above example, the method call to generate the debug message is as follows:

// debug statement
System.out.printIn(“score=” + strScore);

This debug message is replaced with the following method call to the first method:

// debug statement
addToQueue(“score=” + strScore);

Alternatively, if no debug messages are present in the application, the first method call may be inserted in the application 12 by executable module 18 (rather than replacing a pre-existing debug message). Also, additional debug messages may be inserted to provide various other messages (e.g. output of other variables, other character strings, or the like).

The executable module 18 also inserts the addToQueue method from the instruction set 16 into the application 12. An example of the addToQueue method is provided below.

public addToQueue(String str)
{

if(curQueueSize == maxQueueSize) // where maxQueueSize

corresponds to the maximum number of messages which can be displayed

{

removeFirstQueueElement( ); // remove the oldest element

}
appendToQueue(str);

}

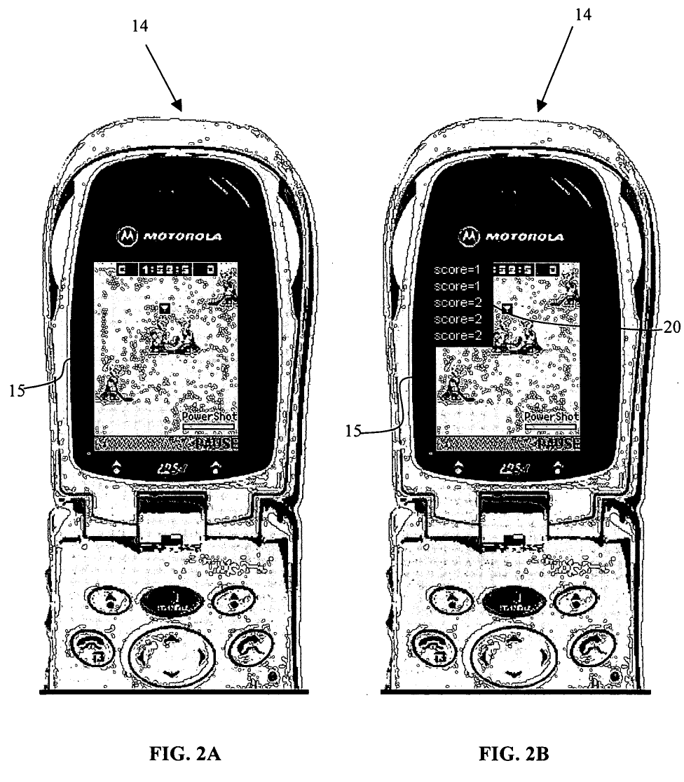

The instruction set 16 inserted by executable module 18 into the application 12 may also include program code which creates a message window 20 (shown in FIG. 2B) on the device display 15 and displays the contents of the queue in the message window. The height and width of the message window 20 is set by the developer. The size of the queue that is displayed is determined by the size of the message window 20 and the default font size of the mobile device 14. In the above example, the software code is appended to the paint method, as follows:

setColor(0); // black color
fillRec(0,0,consoleWidth, maxQueueSize * characterHeight); // draw the
black rectange as shown in figure 2
setColor(0xFFFFFF); // white color
for(y=0; y < maxQueueSize; y++)
{

drawString(0, y * characterHeight, getQueueElement(y));
//

getQueueElement returns the string object stores at the specified location
of
the queue.
}

After the above program code from the instruction set 16 is inserted into the application 12 by the executable module 18, the application 12 is loaded on the mobile device 14 (step 56) and executed (step 58).

FIG. 2A shows a sample screen shot of the execution of the application 12. In this example, the application 12 is the Powershot™ Hockey video game.

During execution, the paint method of the application 12 (such as the exemplary paint method described above) is intercepted after the method is executed but before it is returned such that the contents of queue are displayed (preferably in chronological order) in the message window 20, as best shown in FIG. 2B.

At step 60, the developer may use the contents of the queue in the message window 20 to view debug messages from the application 12. The developer may the use the information to alter the code in the working copy of the application (i.e. the copy application without the additional code required to output the debug messages on the message window).

The present invention provides the advantage of enabling a developer to display debug messages on the display of the mobile device during execution of the application, regardless whether a particular mobile device supports a debug message window. The present invention also enables the developer to add the foregoing functionality in bytecode form, without modifying the source code of the application.

While the above embodiment is particularly suitable for locating simple application logic errors and problems, additional embodiments of the invention may be more suitable when dealing with other errors, such as unexpected quitting or freezing (referred to as “crashing”) of the application 12. In such situations, the message window 20 of the first embodiment may not be visible on the display 15 of the mobile device 14 when the error occurs. Consequently, one or more of the most recent debug messages which are likely critical to locating the problem may be lost.

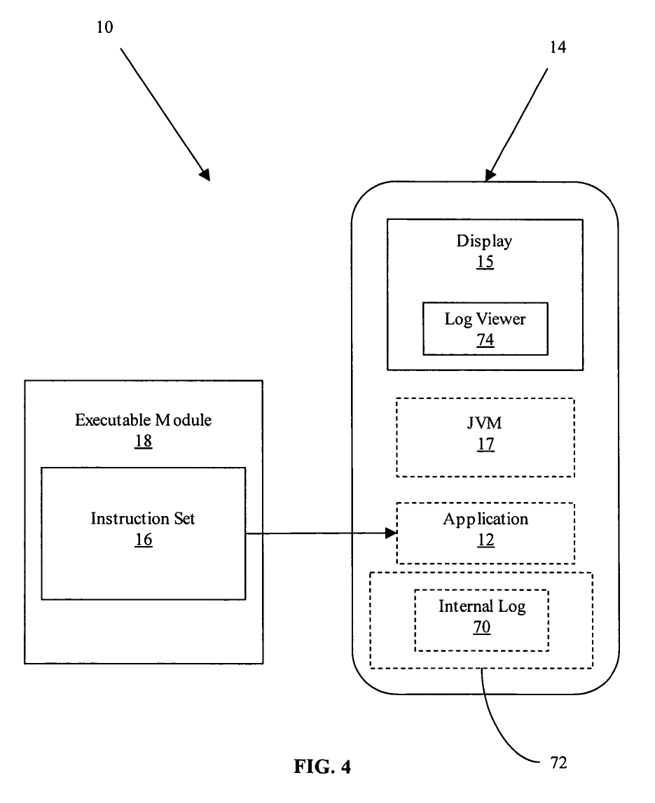

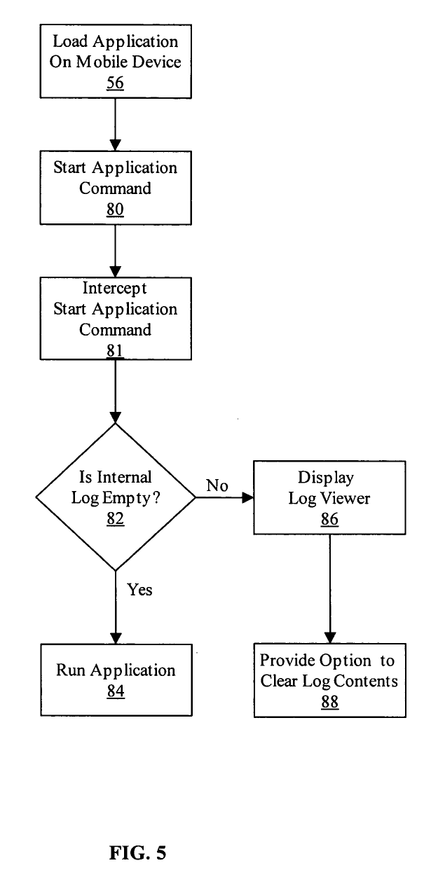

Accordingly, a second embodiment of the present invention is described below with reference to FIGS. 4 and 5. The second embodiment is more suitable for dealing with application crashing.

Referring to FIG. 4 where like parts have been assigned like reference numbers, the debug messages in the application 12 may be replaced by method calls in the instruction set 16 in a similar fashion to that described above. However, instead of program code for generating a message window to display the debug messages, the instruction set 16 includes program code to add the queue containing the debug messages to an internal log 70 in chronological order and to store the log in persistent memory 72 of the mobile device 14. For J2ME enabled devices, the internal log 70 may be stored using the RecordStore method. For Windows™ based mobile devices, the log may be stored using the native file system in the Windows™ Mobile Environment. This program code is inserted into the application 12 by the executable module 18 in the same fashion as described for the first embodiment above.

Referring to FIGS. 4 and 5 (where like steps are assigned like reference numbers), after the above code is inserted, the application 12 is loaded on the mobile device 14 (step 56) and started (step 80). The start application command is intercepted at step 81. If the internal log 70 is empty (decision diamond 82), then the application is executed as usual at step 84. If the internal log 70 is not empty (decision diamond 82), the application does not start, and instead, the contents of the log are displayed on the display 15 of the mobile device 14 on a log viewer 74 (step 86). The developer is given the option to dismiss the log viewer 74 at step 88. When the log viewer 74 is dismissed by the developer, the contents of the internal log 70 are cleared. Accordingly, when the application 12 is launched, the internal log 70 will be empty and the application will start as normal. The log viewer 74 will be displayed only if, in the previous execution, debug messages were generated and stored in the internal log 70.

Set out below is an example of software code inserted into the startApp method of the application 12 to implement the log viewer 74.

StartApp( )
{

if(log is not empty)
{

displayLog( ); //will show the log, when the log viewer is
closed, will also

clear the log

}
else
{

original startApp code is executed here

}

}

Certain mobile devices may have little persistent memory available (as little as 2K) and a small display. Such devices my have insufficient persistent memory for storing log contents and a display size that makes inconvenient to view debug messages on a message window on the device display. Consequently, the first and second embodiments of the present invention may not be particularly suitable for such devices.

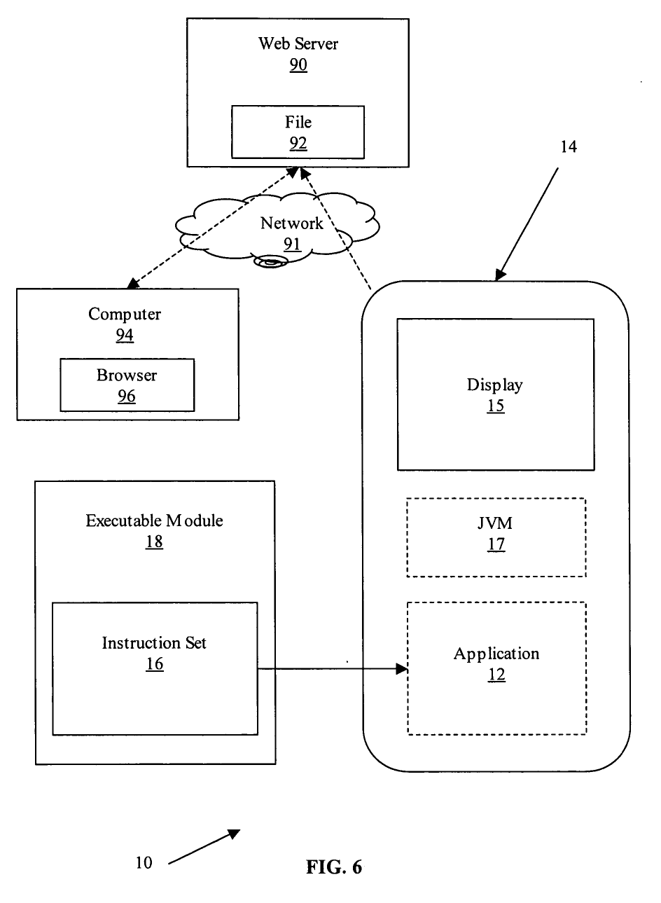

Accordingly, a third embodiment of the invention which is more suitable for devices with little persistent memory and small display size is described below with reference to FIG. 6.

The debug messages in the application 12 may be replaced by method calls in the instruction set 16 in a similar fashion to that described for the first embodiment. As also described in the first embodiment, the executable module 18 inserts into the application 12 the first method which adds the output of the debug message into a first-in-first-out-queue. Preferably, the queue is an array.

In addition, the executable module 18 also injects program code which intercepts the start of the application and starts a background thread to monitor the queue. If the queue is not empty, the first debug message in the queue is sent preferably to a web server 90 over a network 91, such as the Internet using http. The web server runs a web application which is capable of accepting debug messages submitted from mobile devices, and storing the messages in a local persistent storage in order to permit viewing of the debug messages by multiple users from remote computers using web browsers. Preferably, the web server 90 is located at an IP address configured by the developer. The web server 90 appends the content of the debug message to a file 92 whose name corresponds to a unique identifier assigned to the application 12. The contents of the file 92 which displays all of the debug messages may be monitored in real time on any web enabled computer 94 using any suitable web browser 96.

Set out below is an example of program code inserted into the startApp method of the application 12 to implement the background thread.

Public void startApp
{

start a background thread
original startApp code

}

An example of the backgound thread is set out below.

Public void run( )
{

while(true)
{

sleep(1000); // sleep for a second such that the other
threads can

proceed

if(queue is not empty)
{

if(sendStringViaHttp(getQueueElement(0)) == true) //
get the first

element in the queue, send it. If successful, it will return true

```
  removeQueueElement(0); // it is sent successfully so
  remove it from
```

the queue

}

}

}

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims.

1. A method of outputting at least one debug message from an application configured to execute on a mobile device having a display, the method comprising:
a) inserting an instruction set into the application, the instruction set adapted to output the at least one debug message;
b) loading the application on the mobile device; and
c) executing the application on the mobile device, wherein the at least one debug message is output during execution of the application.

2. The method of claim 2, wherein the executing step comprises displaying the at least one debug message on the display of the mobile device.

3. The method of claim 1, wherein the inserting step comprises inserting a first method call to a first method, the first method adapted to add the at least one debug message to a queue.

4. The method of claim 3, wherein the queue comprises a plurality of the debug messages.

5. The method of claim 4, wherein the queue is a first-in-first-out queue.

6. The method of claim 5, wherein the queue comprises an array.

7. The method of claim 4, wherein the inserting step comprises inserting a program code adapted to display the contents of the queue on a message window on the display, wherein the program code is executed in sequence following the execution of a portion of the application adapted to generate output to the display.

8. The method of claim 4, further comprising storing the contents of the queue in an internal log, the internal log being stored in a persistent memory of the mobile device.

9. The method of claim 8, further comprising viewing the internal log on the display after execution of the application is completed or terminated.

10. The method of claim 4, further comprising sending the contents of the queue to a server via a network connection.

11. The method of claim 10, wherein the server comprises a remote web server, wherein the sending step comprises sending the contents of the queue to the web server via a http connection.

12. The method of claim 11, further comprising appending the debug message to a file stored on the web server.

13. The method of claim 12, further comprising viewing the contents of the file on a web browser application running on a computer located remotely from the web server, wherein the file is adapted to store debug messages.

14. A system for outputting a debug message from an application configured to execute on a mobile device having a display, the system comprising:
a) an instruction set adapted to output the debug message during execution of the application; and
b) an executable module adapted to insert the instruction set into the application.

15. The system of claim 14, wherein the instruction set is in bytecode form.

16. The system of claim 14, wherein the instruction set comprises a first method call adapted to add the debug message to a queue.

17. The system of claim 16, wherein the queue comprises an array.

18. The system of claim 16, further comprising an internal log stored in a persistent memory of the mobile device, wherein the internal log is adapted to store the queue.

19. The system of claim 15, further comprising a server connected to the mobile device by a network, wherein the mobile device is adapted to send the queue to the server.

20. The system of claim 19, further comprising a file stored on the server, wherein the debug message is appended to the file.

21. The system of claim 20, wherein the server comprises a web server, the system further comprising a web browser application adapted to run on a computer located remotely from the web server, wherein the file is adapted for viewing on the web browser application.
